(19) United States
(12) Patent Application Publication
(10) Pub. No.: US 2023/0025051 A1
(43) Pub. Date: Jan. 26, 2023

(54) SYSTEM AND METHOD TO PROVIDE SELECTIVE CALL FORWARDING FACILITY

(71) Applicant: GUHAPRIYA MOHANRAJ, CHENNAI (IN)

(72) Inventor: GUHAPRIYA MOHANRAJ, CHENNAI (IN)

(21) Appl. No.: 17/758,406

(22) PCT Filed: Dec. 16, 2020
(86) PCT No.: PCT/IB2020/062019

§ 371 Date: Jul. 6, 2022

(30) Foreign Application Priority Data
Feb. 3, 2020 (IN) 202041004613

(51) Int. Cl. H04M 3/54

(52) U.S. Cl. CPC H04M 3/54

(57) ABSTRACT

A system to provide selective call forwarding facility is disclosed. The system includes a contact grouping module, configured to group a set of contacts for forwarding calls in real time. The system includes a call status detection module, configured to detect the real time calling status of the user. The system includes an automated call forwarding message module, configured to pre-purpose a first message for forwarding an incoming call in accordance to selected contact from a set of grouped contacts. The system includes a call forwarding acknowledgement module, configured to provide real time acknowledgement to the user about call forwarding status. Here, a user may manually select a person from a pre-listed group and intimate the network service provider to forward the call to a selected person.

### CROSS-REFERENCE TO RELATED APPLICATION

This National Phase Application claims priority from a complete patent application filed in India having Patent Application No. 202041004613, filed on Feb. 3, 2020, and titled “SYSTEM AND METHOD TO PROVIDE SELECTIVE CALL FORWARDING FACILITY.”

### FIELD OF INVENTION

Embodiments of a present disclosure relates to service features provided by a phone system, and more particularly to a system and a method to provide selective call forwarding facility.

### BACKGROUND

With the increase in phone services, there is an increase in inbound calls simultaneously at the same time. Opting for right technology and strategy becomes important to address above stated issue. Such problem is solved by call forwarding feature, and important for both personal purpose as well as business purpose. The call forwarding is an important factor as such features provide better customer-agent interactions, multiple extensions for same number and showcasing better presence to everybody.

In one approach, the system detects an incoming call and allows a user to forward the incoming call to a pre-selected contact. Here, the network service provider in tum forwards the incoming call to specific pre-selected contact as stated by the user. Most efficient approach would be to dynamically select in real time the specific contact, a user wants to forward. Such features will provide the user with options for forwarding calls as needed. Moreover, the system should also provide the user success details about the call forwarding.

Another additional effective feature would also be to stop the call forwarding after successful call forward. Thereby, providing again options for forwarding call to different selected contact person in real time.

Hence, there is a need for an improved system to provide selective call forwarding facility and a method to operate the same and therefore address the aforementioned issues.

### BRIEF DESCRIPTION

In accordance with one embodiment of the disclosure, a system to provide selective call forwarding facility is disclosed. The system includes a contact grouping module operable by one or more processors. The contact grouping module is configured to group a set of contacts for forwarding calls in real time. The system also includes a call status detection module operable by the one or more processors. The call status detection module is configured to detect the real time calling status of the user.

The system also includes an automated call forwarding message module operable by the one or more processors. The automated call forwarding message module is operatively coupled to the contact grouping module. The automated call forwarding message module is configured to pre-purpose a first message for forwarding an incoming call in accordance to selected contact from a set of grouped contacts.

The system also includes a call forwarding acknowledgement module operable by the one or more processors. The call forwarding acknowledgement module is operatively coupled to the automated call forwarding message module. The call forwarding acknowledgement module is configured to provide real time acknowledgement to the user about call forwarding status.

In accordance with one embodiment of the disclosure, a method for providing selective call forwarding facility is disclosed. The method includes grouping a set of contacts by a user for forwarding calls in real time. The method also includes detecting the real time calling status of the user. The method also includes pre-purposing a first message to a corresponding network service provider for forwarding an incoming call in-accordance to a selected contact from a set of grouped contacts. The method also includes acknowledging in real time to the user about call forwarding status.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to provide selective call forwarding facility in accordance with an embodiment of the present disclosure;

FIG. 2 is a schematic representation of an embodiment representing the system to provide selective call forwarding facility of FIG. 1 in accordance of an embodiment of the present disclosure;

FIG. 3 is a block diagram of a computer or a server in accordance with an embodiment of the present disclosure; and

FIG. 4 is a flowchart representing the steps of a method for providing selective call forwarding facility in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system to provide selective call forwarding facility. The system includes a contact grouping module operable by one or more processors. The contact grouping module is configured to group a set of contacts for forwarding calls in real time. The system also includes a call status detection module operable by the one or more processors. The call status detection module is configured to detect the real time calling status of the user.

The system also includes an automated call forwarding message module operable by the one or more processors. The automated call forwarding message module is operatively coupled to the contact grouping module. The automated call forwarding message module is configured to pre-puipose a first message for forwarding an incoming call in accordance to selected contact from a set of grouped contacts.

The system also includes a call forwarding acknowledgement module operable by the one or more processors. The call forwarding acknowledgement module is operatively coupled to the automated call forwarding message module. The call forwarding acknowledgement module is configured to provide real time acknowledgement to the user about call forwarding status.

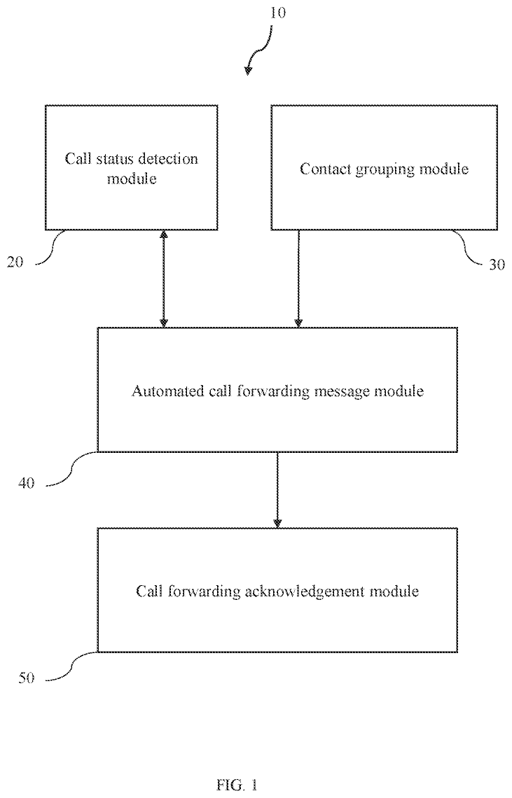

FIG. 1 is a block diagram representation of a system 10 to provide selective call forwarding facility in accordance with an embodiment of the present disclosure. As used herein, the term “call forwarding” refers to a telephone feature of some telephone switching systems which redirects a telephone call to another destination, which may be, for example, a mobile or another telephone number where the desired called party is available.

The system 10 includes a contact grouping module 30 operable by one or more processors. The contact grouping module 30 is configured to group a set of contacts for forwarding calls in real time. In such embodiment, the set of contacts are selected manually by a user of the system 10. Here, in one embodiment, the user refers to individual using the system to forward an incoming call.

The system 10 also includes a call status detection module 20 operable by the one or more processors. The call status detection module 20 is configured to detect the real time calling status of the user. In one exemplary embodiment, the call status detection module 20 is configured to detect the status of the phone the user is having. In such exemplary embodiment, the user's phone may be busy on another call.

The system 10 also includes an automated call forwarding message module 40 operable by the one or more processors. The automated call forwarding message module 40 is operatively coupled to the contact grouping module 30. The automated call forwarding message module 40 is configured to pre-purpose a first message for forwarding an incoming call in accordance to selected contact from a set of grouped contacts.

In one specific exemplary embodiment, as the phone of the user might be busy, the system 10 here is configured to forward the incoming call to one selected contact as selected through the contact grouping module 30. Here, the call status detection module 20 first detects the user's phone status. As condition detected is busy, any further incoming call is forwarded to another selected contact number.

In such embodiment, on receiving any incoming call, the user may manually give permission to forward to any particular selected contact. In another such embodiment, if the selected contact is busy, the user call is forwarded to next rank selected contact. Ranking style is being used to send one after another selected contact details. Furthermore, selected ranked contact group may also be given permission for call forwarding facility.

In above stated specific embodiment, after user's permission on forwarding the call, the system 10 via the automated call forwarding message module 40 forwards a pre-purpose first message to a corresponding network service provider.

In one embodiment, the first message comprises details of the selected contact from the set of grouped contacts such as contact details, network service name, contact name and the like. In such embodiment, the network service providers are service provider organization that provides calling services as well as internet backbone infrastructure and services.

Furthermore, after intimation from the user with the details of the selected group of contact, the network service provider connects the incoming call to the selected contact person. Here, after such connection, the system 10 provides real time acknowledgement to the user about call forwarding status via a call forwarding acknowledgement module 50. The system 10 also includes call forwarding acknowledgement module 50 operable by the one or more processors. The call forwarding acknowledgement module 50 is operatively coupled to automatic call forwarding message module 40. In one embodiment, the acknowledgement mainly comprises details of successful call forward.

In another embodiment, after successful call forward the network service provider may automatically stop the call forwarding to the selected contact number.

Furthermore, the system 10 also includes a storage module operable by the one or more processors. The storage module is operatively coupled to the contact grouping module 30. The storage module is configured to store the list of contacts as created. In one embodiment, the storage may be in a local storage or a remote storage.

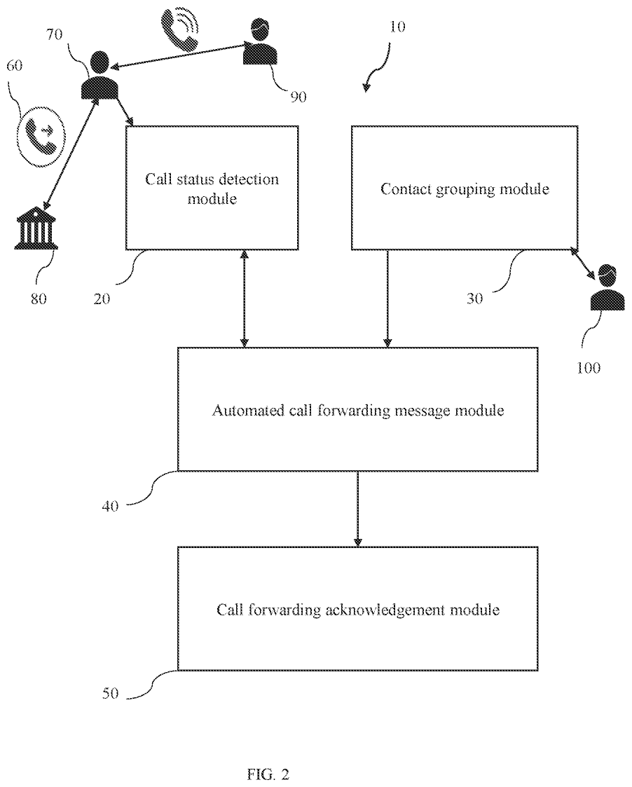

FIG. 2 is a schematic representation of an embodiment representing the system 10 to provide selective call forwarding facility of FIG. 1 in accordance of an embodiment of the present disclosure. In an exemplary situation, there is an ongoing call 60 between a user X 70 and office Z 80 and here, the user X 70 simultaneously receives a call from a user M 90.

Here, the user X 70 has three options. Firstly, the user X 70 may reject the incoming call of the user M 90. Secondly, the user X 70 may accept the user M 90 call and cancel the office Z 80 call. Lastly, the user X 70 may use call forward facility.

In last situation, the user X 70 may have previously stored a selected group of contacts via a contact grouping module 30. Here, the contact grouping module 30 enables the user X 70 to select a person from the group of alternative contacts. The system via the contact grouping module 30 also ranks grouped list, so if one contact is busy other contact is connected instantaneously.

In this particular situation, as the user X 70 and office Z 80 is having call, the user X 70 manually selects contact number 1 100 to initiate call forwarding facility. Here, a call status detection module 20 enables detection of an ongoing call in relation to the user X 70 phone.

Further, an automated call forwarding message module 40 forwards automatically contact number 1 100 details to network service provider of user X 70. The network service initiates user M 90 call with contact number 1 100, after receiving details in relation to contact number 1 100. Here, the details contained contact details, network service name, contact name and the like.

Furthermore, the user X 70 receives acknowledgement of call forward success via a call forwarding acknowledgement module 50. Here, acknowledgement may be purposed text message stating success of call forward connection. After, successful call forward, the network service provider of user X 70 stops the call forward facility to the selected contact number 1 100.

The contact grouping module 30, the call status detection module 20, the automated call forwarding message module 40 and the call forwarding acknowledgement module 50 in FIG. 2 is substantially equivalent to the contact grouping module 30, the call status detection module 20, the automated call forwarding message module 40 and the call forwarding acknowledgement module 50 of FIG. 1.

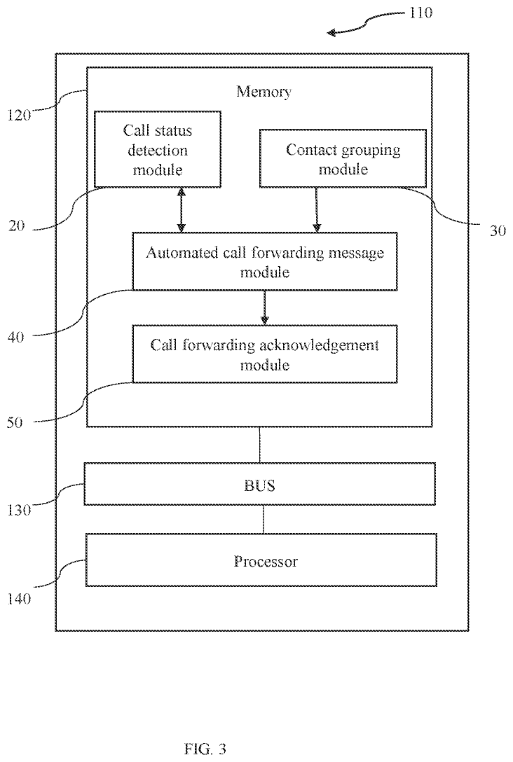

FIG. 3 is a block diagram of a computer or a server 110 in accordance with an embodiment of the present disclosure. The server 110 includes processor(s) 140, and memory 120 coupled to the processor(s) 140.

The processor(s) 140, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 120 includes a plurality of modules stored in the form of executable program which instructs the processor 140 to perform the method steps illustrated in FIG. 1. The memory 120 has following modules: the contact grouping module 30, the call status detection module 20, the automated call forwarding message module 40 and the call forwarding acknowledgement module 50.

The contact grouping module 30 is configured to group a set of contacts for forwarding calls in real time. The call status detection module 20 is configured to detect the real time calling status of the user. The automated call forwarding message module 40 is configured to pre-purpose a first message for forwarding an incoming call in accordance to selected contact from a set of grouped contacts. The call forwarding acknowledgement module 50 is configured to provide real time acknowledgement to the user about call forwarding status.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 140.

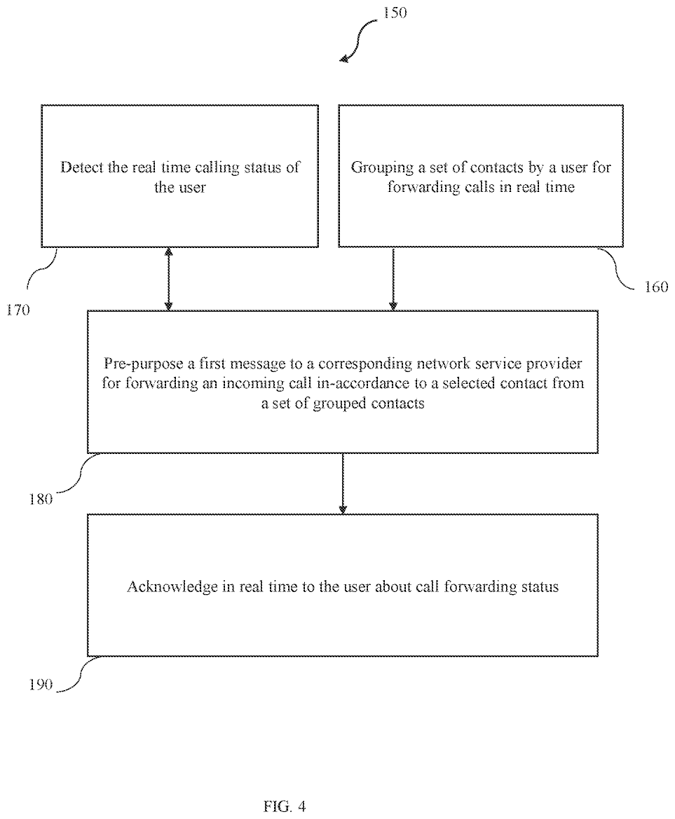

FIG. 4 is a flowchart representing the steps of a method 150 for providing selective call forwarding facility in accordance with an embodiment of the present disclosure. The method 150 includes grouping a set of contacts by a user for forwarding calls in real time in step 160.

In one embodiment, grouping the set of contacts by the user for forwarding calls in real time includes grouping the set of contacts by the user for forwarding calls in real time by a contact grouping module. In another embodiment, grouping the set of contacts by the user for forwarding calls in real time includes grouping the set of contacts in ranks for forwarding calls.

The method 150 also includes detecting the real time calling status of the user in step 170. In one embodiment, detecting the real time calling status of the user includes detecting the real time calling status of the user by a call status detection module.

The method 150 also includes pre-purposing a first message to a corresponding network service provider for forwarding an incoming call in-accordance to a selected contact from a set of grouped contacts in step 180. In one embodiment, pre-purposing the first message to the corresponding network service provider for forwarding the incoming call in-accordance to the selected contact from the set of grouped contacts includes pre-purposing the first message to the corresponding network service provider for forwarding the incoming call in-accordance to the selected contact from the set of grouped contacts by an automated call forwarding message module.

In another embodiment, pre-purposing the first message to the corresponding network service provider for forwarding the incoming call in-accordance to the selected contact from the set of grouped contacts includes pre-purposing the first message for forwarding the call is based on the calling status of the user. In such embodiment, pre-purposing the first message to the corresponding network service provider for forwarding the incoming call in-accordance to the selected contact from the set of grouped contacts includes pre-purposing the first message comprising details of the selected contact from the set of grouped contacts.

The method 150 also includes acknowledging in real time to the user about call forwarding status in step 190. In one embodiment, acknowledging in real time to the user about the call forwarding status includes acknowledging in real time to the user about the call forwarding status by a call forwarding acknowledgement module.

Present disclosure of a call forwarding facility is an effective way to forward a call to a selected person in real time. Here, a user may manually select a person from a pre-listed group and ask the network service provider to forward the call to that selected person. The system additionally provides a real time acknowledgement about the successful call forward.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional eletnents. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

I claim:

1. A system to provide selective call forwarding facility, comprising:
a contact grouping module operable by one or more processors and configured to group a set of contacts for forwarding calls in real time, wherein the set of contacts is ranked by a user for facilitating call forwarding;
a call status detection module operable by the one or more processors and configured to detect the real time calling status of the user;
an automated call forwarding message module operable by the one or more processors, and operatively coupled to the contact grouping module, wherein the automated call forwarding message module is configured to pre-purpose a first message for forwarding an incoming call in accordance to selected contact from a set of grouped contacts,
wherein the first message for call forwarding is forwarded to a corresponding network service provider based on the calling status of the user; and
a call forwarding acknowledgement module operable by the one or more processors, and operatively coupled to the automated call forwarding message module, wherein the call forwarding acknowledgement module is configured to provide real time acknowledgement to the user about call forwarding status.

2. The system as claimed in claim 1, wherein the user prioritizes each of the set of contacts according to ranks for forwarding calls.

3. The system as claimed in claim 1, wherein the first message comprises details of the selected contact from the set of grouped contacts.

4. A method for providing selective call forwarding facility, comprising:
grouping, by a contact grouping module, a set of contacts by a user for forwarding calls in real time,
detecting, by a call status detection module, the real time calling status of the user;
pre-purposing, by an automated call forwarding message module, a first message to a corresponding network service provider for forwarding an incoming call in-accordance to a selected contact from a set of grouped contacts; and
acknowledging, by a call forwarding acknowledgement module, in real time to the user about call forwarding status.

5. The method as claimed in claim 5, wherein pre-purposing, by the automated call forwarding message module, the first message for forwarding the call is based on the calling status of the user.

6. The method as claimed in claim 5, wherein grouping, by the contact grouping module, the set of contacts is prioritized in ranks for forwarding calls.

7. The method as claimed in claim 5, wherein pre-purposing, by the automated call forwarding message module, the first message comprising details of the selected contact from the set of grouped contacts.
